(19) United States
(12) Patent Application Publication
(10) Pub. No.: US 2015/0158242 A1
(43) Pub. Date: Jun. 11, 2015

(54) IMPRINT DEVICE AND TEMPLATE

(71) Applicant: TOKYO ELECTRON LIMITED, Tokyo (JP)

(72) Inventors: Kenya Iwasaki, Tokyo (JP); Hiroaki Fusano, Tokyo (JP); Takaaki Hirooka, Miyagi (JP); Takeshi Nagao, Yamanashi (JP); Hiroyuki Nakayama, Yamanashi (JP)

(73) Assignee: TOKYO ELECTRON LIMITED, Tokyo (JP)

(21) Appl. No.: 14/405,916

(22) PCT Filed: May 30, 2013
(86) PCT No.: PCT/JP2013/003423

§ 371 Date: Dec. 5, 2014

(30) Foreign Application Priority Data
Jun. 7, 2012 (JP) 2012-129475

(51) Int. Cl. B29C 59/16; B29C 59/00

(52) U.S. Cl. CPC B29C 59/16; B29C 59/002; B29L 2031/772

(57) ABSTRACT

An imprint device includes a template provided with a plate-shaped template body and a pattern portion having a predetermined shape formed on a surface of the template body; a template holding mechanism configured to hold the template; a substrate holding mechanism configured to hold a substrate formed with a resin layer made of a photo-curable resin in a state where the pattern portion of the template and the resin layer are in contact with each other; and a light irradiating mechanism configured to irradiate a light in a wavelength range for curing the photo-curable resin. The template allows the light to be incident from a lateral surface of the template body, and the light irradiating mechanism irradiates the light to the resin layer by allowing the light to be incident from the lateral surface of the template body and transmitted through the template body.

### TECHNICAL FIELD

The present disclosure relates to an imprint device and a template.

### BACKGROUND

An imprint technique has been known in the related art, in which a predetermined pattern shape of a template is transferred to a resin layer made of a resin polymerized and solidified by irradiation of a light such as, for example, ultraviolet rays by forming the resin layer on a substrate such as, for example, a semiconductor wafer or a glass substrate for a liquid crystal display (LCD), bringing the template into contact therewith, and solidifying the resin layer by irradiation of ultraviolet rays in this state.

Such an imprint device for performing such an imprint process generally includes a template formed of a material capable of transmitting ultraviolet rays for curing a resin layer, and is configured to irradiate the resin layer with ultraviolet rays transmitted through the template from a rear surface of the template (a surface opposite to a pattern forming surface) in a state where the pattern forming surface and the resin layer are in contact with each other (see, e.g., Patent Document 1).

### PRIOR ART DOCUMENT

### Patent Document

Patent Document 1: Japanese Patent Laid-Open Publication No. 2007-150053

### DISCLOSURE OF THE INVENTION

### Problems to be Solved

As described above, the conventional imprint device is generally configured to irradiate ultraviolet rays from the rear surface of the template in a state where the template and the resin layer are in contact with each other. However, in the imprint device having such a configuration, when a structure is present on the rear surface of the template, the ultraviolet rays may be blocked by the structure so that a curing irregularity may be generated. Thus, a good resin pattern may not be formed. Further, since a structure to be disposed on the rear surface of the template is limited, a holding performance of the template may become insufficient. Thus, for example, a warpage may be generated on the template and a good resin pattern may not be formed.

The present disclosure has been made in consideration of the above problems in the related art, and an object thereof is to provide an imprint device and a template, which ensure to form a resin pattern in a good shape.

### Means to Solve the Problems

According to an aspect, the present disclosure provides an imprint device including a template provided with a plate-shaped template body and a pattern portion having a predetermined shape formed on a surface of the template body; a template holding mechanism configured to hold the template; a substrate holding mechanism configured to hold a substrate formed with a resin layer made of a photo-curable resin in a state where the pattern portion of the template and the resin layer are in contact with each other; and a light irradiating mechanism configured to irradiate a light in a wavelength range for curing the photo-curable resin. The template is configured to allow the light to be incident from a lateral surface of the template body, and the light irradiating mechanism is configured to irradiate the light to the resin layer by allowing the light to be incident from the lateral surface of the template body and transmitted through the template body.

According to another aspect, the present disclosure provides a template including a plate-shaped template body; and a pattern portion having a predetermined shape formed on a surface of the template body. The template is configured to transfer the shape in the pattern portion to a resin layer made of a photo-curable resin by holding a substrate formed with the resin layer in a state where the pattern portion and the resin layer are in contact with each other, and curing the resin layer by irradiation of a light. The template is configured such that the light is incident from a lateral surface of the template body, and the resin layer is irradiated with the light by allowing the light to be incident from the lateral surface of the template body and transmitted through the template body.

### Effect of the Invention

The present disclosure may provide an imprint device and a template which ensures that a resin pattern may be formed in a good shape.

### BRIEF DESCRIPTION OF THE DRAWINGS

FIG. 1 illustrates views for describing steps of an imprint method according to an exemplary embodiment of the present disclosure.

FIG. 2 is a view illustrating a configuration of a dropping/application module according to an exemplary embodiment.

FIG. 3 is a view illustrating a configuration of an imprint module according to an exemplary embodiment.

FIG. 4 is a view illustrating a configuration of an imprint device according to an exemplary embodiment.

FIG. 5 is a view illustrating another configuration example of the imprint device according to the exemplary embodiment.

FIG. 6 is a view illustrating still another configuration example of the imprint device according to the exemplary embodiment.

FIG. 7 illustrates a configuration example of a main portion of the imprint device according to the exemplary embodiment.

FIG. 8 illustrates another configuration example of the main portion of the imprint device according to the exemplary embodiment.

FIG. 9 is a view illustrating another configuration example of the imprint module according to the exemplary embodiment.

FIG. 10 is a view illustrating still another configuration example of the imprint module according to the exemplary embodiment.

FIG. 11 is a view illustrating yet another configuration example of the imprint module according to the exemplary embodiment.

FIG. 12 illustrates micrographs representing a difference in curing states of a resin.

FIG. 13 is a view illustrating still yet another configuration example of the imprint module according to the exemplary embodiment.

FIG. 14 is a view illustrating a configuration according to an exemplary embodiment in which an undercoat layer is provided.

### DETAILED DESCRIPTION TO EXECUTE THE INVENTION

Hereinafter, exemplary embodiments of the present disclosure will be described with reference to the drawings.

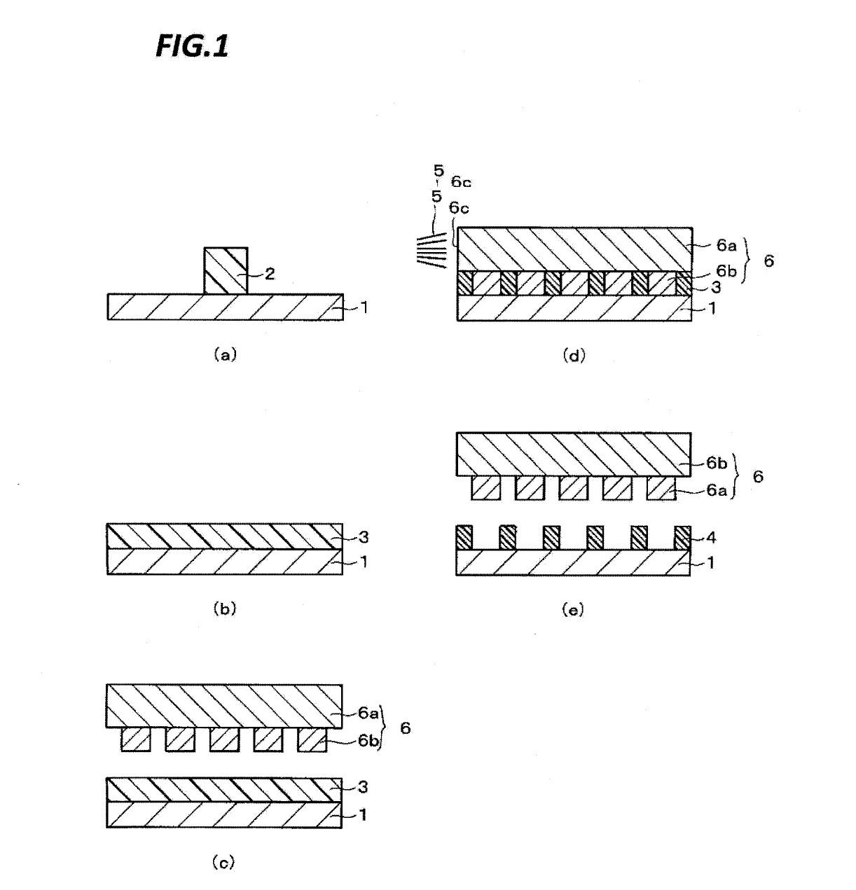

FIG. 1 schematically illustrates steps of an imprint method according to an exemplary embodiment of the present disclosure. The imprint method is to form a resin pattern 4 having a predetermined shape formed on a resin layer 3, such as an etching mask or a lens for optical devices, on a substrate 1 such as, for example, a semiconductor wafer or a glass substrate for a liquid crystal display (LCD).

As illustrated in FIG. 1, in the imprint method, a photo-curable resin 2 is first dropped approximately on a center of the substrate 1 (FIG. 1(a)). The photo-curable resin 2 is a resin polymerized and cured by irradiation of a light, for example, ultraviolet rays. The photo-curable resin 2 may be made of, for example, epoxy resins or acrylic resins.

Next, the photo-curable resin 2 dropped onto the substrate 1 is applied and spread on the whole surface of the substrate 1 to form the resin layer 3 made of the photo-curable resin 2 (FIG. 1(b)). Further, in this case, a spin coater may be used to rotate the substrate 1 so as to cause spreading by a centrifugal force as described below. Further, the thickness of the resin layer 3 is set to, for example, several microns (e.g., 1 μm to 10 μm).

Next, a template 6 is positioned to face the resin layer 3 (FIG. 1(c)), and brought into contact with the resin layer 3. In this state, ultraviolet rays are irradiated to the resin layer 3 to cause solidification by polymerization to proceed in the resin layer 3 (FIG. 1(d)).

Here, the template 6 is provided with a plate-shaped template body 6a and a pattern portion 6b having a predetermined shape formed on a surface of the template body 6a, and the template body 6a is configured to allow a light in a wavelength range for curing the photo-curable resin 2 (the ultraviolet rays 5 in the present exemplary embodiment) to be incident from a sidewall 6c thereof. Then, the resin layer 3 is irradiated with the ultraviolet rays 5 incident from the sidewall 6c into the template body 6a and transmitted through the template body 6a.

Next, the resin layer 3 is solidified by polymerization. After the shape (the resin pattern 4) transferred to the resin layer 3 is maintained even though the template 5 is released, a releasing step is performed to release the template 6 from the resin layer 3 (the resin pattern 4) (FIG. 1(e)).

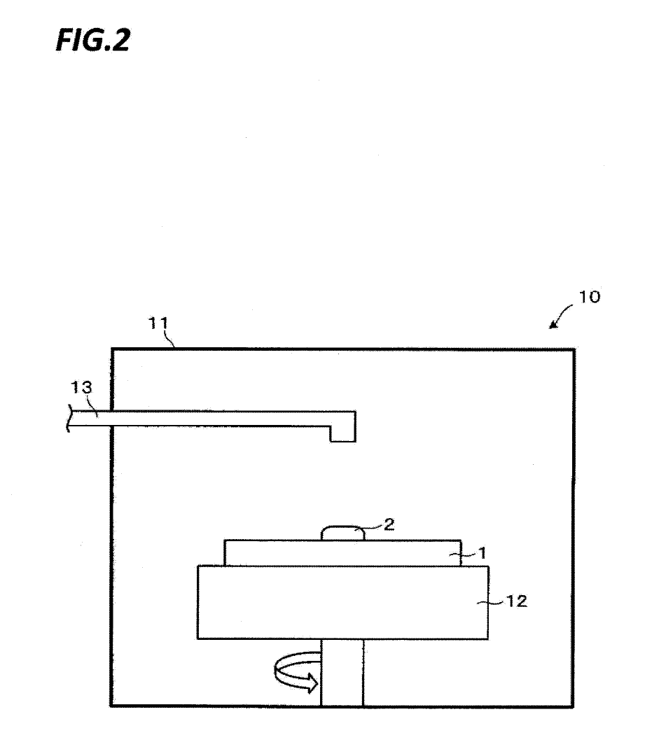

Next, an imprint device according to the present exemplary embodiment will be described. A dropping/application module 10, for example, as illustrated in FIG. 2 may be used for the step of dropping the photo-curable resin 2 onto the substrate 1, and the step of applying the dropped photo-curable resin 2 onto the substrate 1 to form the resin layer 3, among the steps of the imprint method of the present exemplary embodiment.

In the dropping/application module 10 illustrated in FIG. 2, a rotary stage 12 configured to rotate the substrate 1 placed thereon, and a nozzle 13 configured to supply the photo-curable resin 2 are provided in a processing chamber 11. Then, the photo-curable resin 2 is dropped from the nozzle 13 approximately onto the center of the substrate 1 placed on the rotary stage 12, and the substrate 1 is rotated by the rotary stage 12 to spread the photo-curable resin 2 dropped on the substrate 1 by a centrifugal force. Therefore, the photo-curable resin 2 is applied on the whole surface of the substrate 1 to form the resin layer.

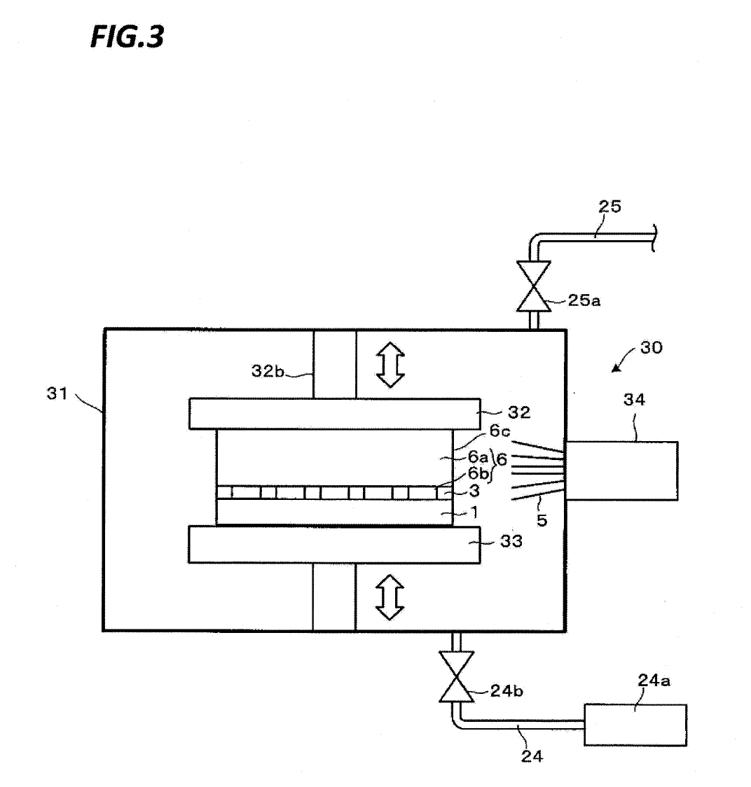

For example, an imprint module 30 illustrated in FIG. 3 may be used for the step of bringing the template 6 into contact with the resin layer 3, the step of irradiating the ultraviolet rays 5 to the resin layer 3, and the step of releasing the template 6 from the resin layer 3 (an imprint process). In the imprint module 30, an upper stage 32 serving as a template holding mechanism that holds the template 6, and a lower stage 33 serving as a substrate holding mechanism that holds the substrate 1 are provided in a processing chamber 31, and a driving mechanism (not illustrate) is also provided in at least one of the stages, which is then caused to be movable vertically. Further, the driving mechanism is provided with an aligning mechanism that aligns the substrate 1 and the template 6.

A UV light sources 34 is provided on a sidewall of the processing chamber 31. A laser beam source, a mercury lamp, or a UV lamp made of, for example, LEDs and having a wavelength of about 365 nm and a power of about 300 mW, may be used as the UV light source 34. Further, the processing chamber 31 is connected with a gas exhaust line 24 and a gas supply line 25 that supplies gas such as nitrogen gas. The gas exhaust line 24 is connected with a vacuum pump 24a, and an exhaust valve 24b in the gas exhaust line 24. Further, a supply valve 25a is interposed in the gas supply line 25.

In the imprint module 30 having the above configuration, the substrate 1 and the template 6 are aligned at a predetermined position, and the template 6 is brought into contact with the resin layer 3 of the substrate 1. Then, the resin layer 3 is cured by irradiating the ultraviolet rays 5 from the UV light source 34. At this time, the template body 6a of the template 6 is formed of a material capable of transmitting the ultraviolet rays 5, and configured such that the ultraviolet rays 5 are introduced from the sidewall 6c of the template body 6a into the template body 6a, transmitted through the template body 6a, and irradiated to the resin layer 3.

Accordingly, although there are structures such as the upper stage 32 and a supporting mechanism 32b that support the upper stage 32 at the rear surface side of the template 6, the ultraviolet rays are not blocked by the structures. Therefore, since the ultraviolet rays may be irradiated to the whole resin layer 3, a resin pattern in a good shape may be securely formed. Further, since the structures provided at the rear surface side of the template 6 is not limited in order to ensure the light path of the ultraviolet rays 5, the template 6 may be securely held. Therefore, a resin pattern in a good shape may be securely formed.

Further, some photo-curable resins (UV curable resins) are difficult to be cured when oxygen is present in an atmosphere. Therefore, the inside of the processing chamber 31 is set to be under a reduced-pressure atmosphere or a nitrogen-filled atmosphere by means of the gas exhaust line 24 and the gas supply line 25. And, as the resin layer 3 is cured, a predetermined pattern formed on the pattern portion 6b of the template 6 is transferred to the resin layer by releasing the template 6 from the resin layer 3 of the substrate 1.

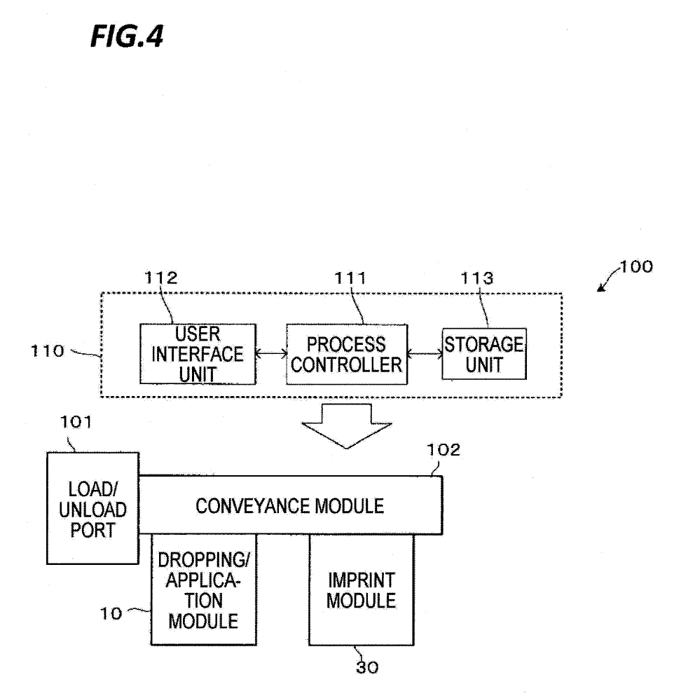

Next, descriptions will be made on an exemplary embodiment of an imprint device 100 configured by combining the dropping/application module 10 and the imprint module 30 having the above-mentioned configuration, with reference to FIG. 4.

In the imprint device 100 illustrated in FIG. 4, a load/unload port 101 is provided at the left end in the figure, and the load/unload port 101 is connected with a conveyance module 102. In addition, the dropping/application module 10 and the imprint module 30 are provided along the conveyance module 102 from the left in the figure.

Further, the imprint device 100 is provided with a controller 110. And, the load/unload port 101, the conveyance module 102, the dropping/application module 10, and the imprint module 30 are integrally controlled by the controller 110.

The controller 110 is provided with a process controller 111 that includes a CPU configured to control each unit of the imprint device 100, a user interface unit 112, and a storage unit 113.

The user interface unit 112 is configured as, for example, a keyboard where an input operation of commands is performed by a process manager in order to manage the imprint device 100, or a display that visualizes and displays an operation status of the imprint device 100.

The storage unit 113 is stored with a control program (software) to implement various processings performed in the imprint device 100 with a control of the process controller 111, or a recipe stored with processing condition data. In addition, when the recipe is called from the storage unit 113 and executed in the process controller 111 by, for example, an instruction from the user interface unit 112 as necessary, a desired processing is performed in the imprint device 100 under the control of the process controller 111. Further, the control program or the recipe such as processing condition data may be stored in a computer-readable storage medium (e.g., a hard disc, a compact disc (CD), a flexible disc, or a semiconductor memory), or transmitted from other devices through a dedicated line from time to time for on-line use.

A hoop or a cassette accommodating, for example, a semiconductor wafer is placed on the load/unload port 101. Then, the semiconductor wafer is taken out from the hoop or cassette by a conveyance robot provided in the conveyance module 102, and first carried into the dropping/application module 10. Then, in the dropping/application module 10, a photo-curable resin is applied on the semiconductor wafer to form a resin layer.

Next, the semiconductor wafer is carried into the imprint module 30 by the conveyance robot of the conveyance module 102. Here, the template is then brought into contact with the resin layer on the semiconductor wafer, and the resin layer is cured by being irradiated with ultraviolet rays so that the shape of the template is transferred to the resin layer on the semiconductor wafer.

Then, after the curing of the resin layer proceeds, the template is released from the resin layer. The semiconductor wafer formed with a resin pattern is placed on the load/unload port 101 by the conveyance robot of the conveyance module 102, and then, accommodated in the hoop or the cassette.

By the above-mentioned steps, the resin pattern (the resin pattern 4 illustrated in FIG. 1) is formed on the semiconductor wafer by the imprint device 100.

Further, in the imprint module 30 illustrated in FIG. 3, the upper stage 32 holding the template 6 may be configured such that a contact surface in contact with the rear surface of the template 6 totally reflects the ultraviolet rays 5 introduced into the template 6. In this case, a material having a refractive index in which a total reflection condition is obtained from the refractive index of the material constituting the template 6 (the template body 6a) and the incidence angle of the ultraviolet rays 5, is selected as the material constituting the contact surface. The whole upper stage 32 may be made of this material, or a layer made of this material may be provided as a coating only on the contact surface in contact with the rear surface of the template 6. For example, in a case where the template 6 (the template body 6a) is made of a glass material (having a refractive index of 1.5), the contact surface may be made of a material having a lower refractive index. Further, the refractive index of the template 6 may be lower than the refractive index of the resin layer 3, and the refractive index of the resin layer 3 may be higher than the refractive index of the substrate 1. When the refractive index of the template body 6a is set to be lower than the refractive index of the resin layer 3, the ultraviolet rays 5, which are introduced into the resin layer 3 and then reflected on the boundary between the resin layer 3 and the substrate 1 to be incident on the template body 6a from the resin layer 3, may be reflected on the boundary between the resin layer 3 and the template body 6a to be directed towards the inside of the resin layer 3. Further, when the refractive index of the resin layer 3 is set to be higher than the refractive index of the substrate 1, the ultraviolet rays 5, which are introduced into the resin layer 3 to be incident from the resin layer 3 to the substrate 1, may be reflected on the boundary between the resin layer 3 and the substrate 1 to be directed towards the inside of the resin layer 3. With such a configuration, the ultraviolet rays 5 introduced into the template 6 may be efficiently introduced into the resin layer 3 of the substrate 1.

Further, in a case where a reflecting unit is configured on the contact surface of the upper stage 32 in contact with the rear surface of the template 6 to reflect the ultraviolet rays 5, a fine unevenness may be formed on the surface of the upper stage 32 so as to roughen the surface. Therefore, the ultraviolet rays 5 introduced into the template 6 may be reflected by the upper stage 32 so as to be efficiently introduced into the resin layer 3 of the substrate 1.

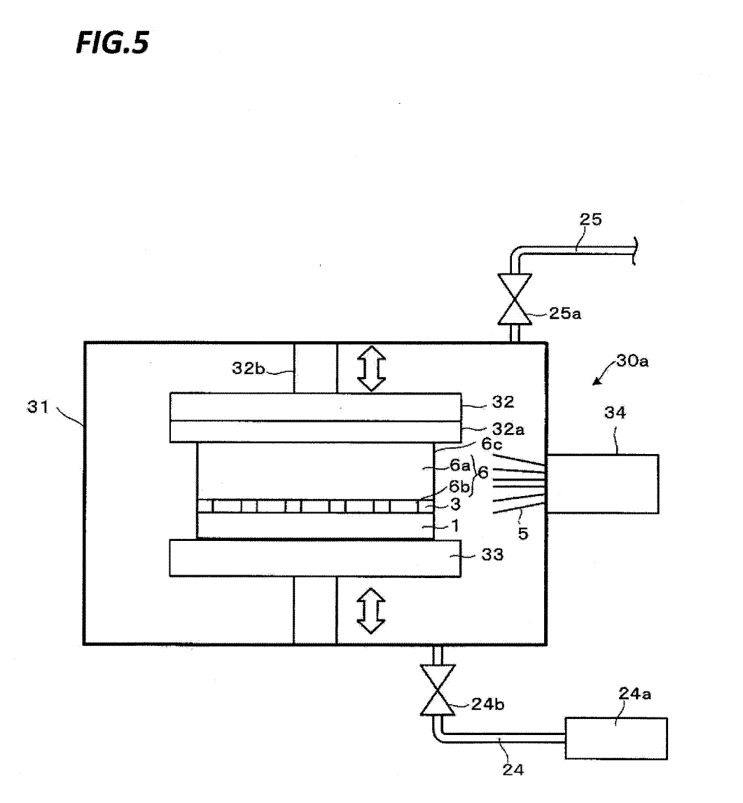

Further, for example, as in an imprint module 30a as illustrated in FIG. 5, a transparent body 32a may be provided between the upper stage 32 and the template 6 to serve as a path of the ultraviolet rays 5 transmitting the ultraviolet rays 5, and the upper stage 32 may be configured as a reflector that reflects the ultraviolet rays 5. With such a configuration, since the ultraviolet rays 5 are able to be incident even from a lateral surface of the transparent body 32a, an incidence amount thereof may increase. Further, since the incident ultraviolet rays 5 are able to be reflected on the upper stage 32 made of the reflector, the ultraviolet rays 5 may be more efficiently introduced into the resin layer 3 of the substrate 1. In this case, the refractive index of the transparent body 32a may be lower than that of the template body 6a. When the refractive index of the transparent body 32a is set to be lower than that of the template body 6a, the ultraviolet rays 5, which are introduced into the template body 6a to be incident from the template body 6a to the transparent body 32a, may be reflected on the boundary between the template body 6a and the transparent body 32a to be directed towards the inside of the template body 6a by setting. Further, the refractive index of the transparent body 32a may be higher than that of the upper stage 32. When the refractive index of the transparent body 32a is set to be higher than that of the upper stage 32, the ultraviolet rays 5, which are introduced into the transparent body 32a to be incident from the transparent body 32a to the upper stage 32, may be reflected on the boundary between the transparent body 32a and the upper stage 32 to be directed towards the inside of the transparent body 32a. With such a configuration, the ultraviolet rays 5 introduced into the template 6 may be efficiently introduced into the resin layer 3 of the substrate 1.

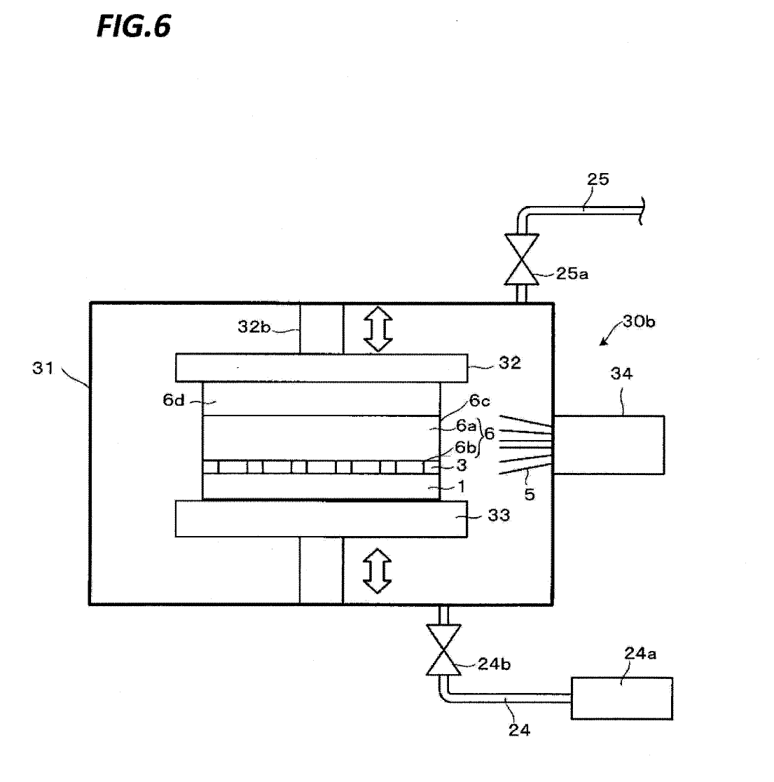

Further, for example, as in an imprint module 30b as illustrated in FIG. 6, a reflector 6d reflecting the ultraviolet rays 5 may be provided on the rear surface of the template 6 (the template body 6a) to reflect the ultraviolet rays 5 on the boundary between the template body 6a and the reflector 6d. Further, in FIGS. 5 and 6, the portions corresponding to the imprint module 30 as illustrated in FIG. 3 will be denoted by the same reference numerals, and the redundant descriptions thereof will be omitted.

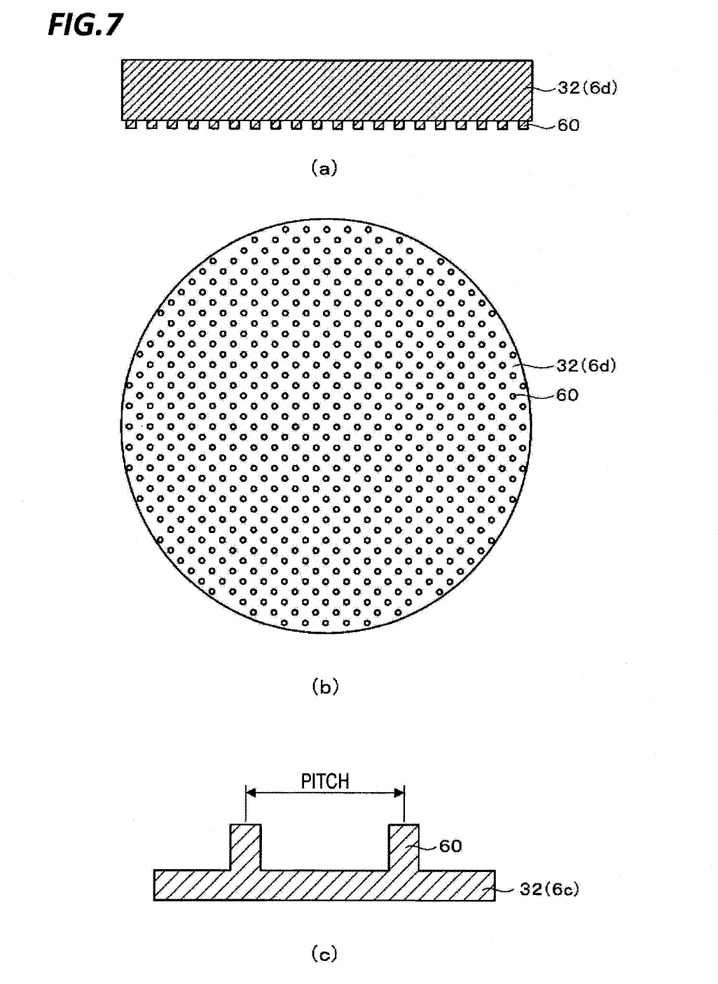

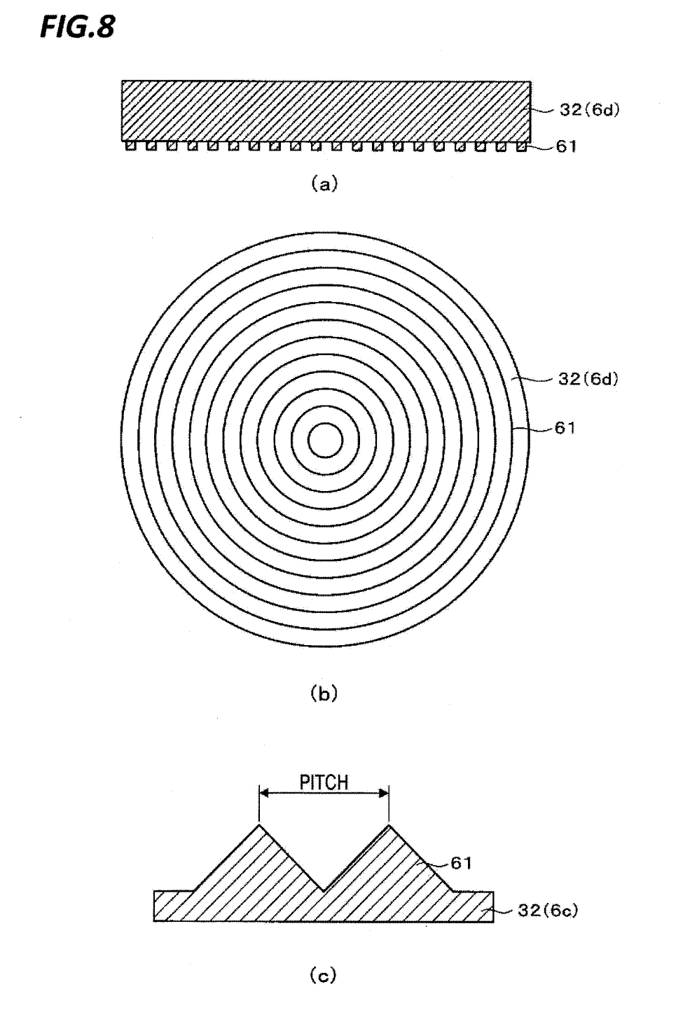

As described above, in the case where the upper stage 32 (or the reflector 6d) is formed with unevenness to reflect the ultraviolet rays 5, a plurality of minute convex portions may be provided on a surface constituting a reflector in a dot shape, for example, as illustrated in FIG. 7(a) to FIG. 7(c). Further, a ridge and valley pattern may be configured such that convex portions are provided concentrically as illustrated in FIG. 8(a) to FIG. 8(c). FIG. 7(a) and FIG. 8(a) illustrate configurations which may be provided on the upper stage 32 (or the reflector 6d) in vertical cross-sections, FIG. 7(b) and FIG. 8(b) illustrate configurations which may be provided on the bottom surface of the upper stage 32 (or the reflector 6d), and FIG. 7(c) and FIG. 8(c) illustrate portions of the configurations which may be provided on the upper stage 32 (or the reflector 6d) in an enlarged scale.

Further, in a case where such unevenness is formed, pitches of the convex portions 60, 61 may be set such that the pitch spaces are narrower from the outer periphery towards the center. When the pitch spaces are narrowed from the outer periphery towards the center in this manner, the light introduced from the outer periphery may be reflected more uniformly on the whole surface.

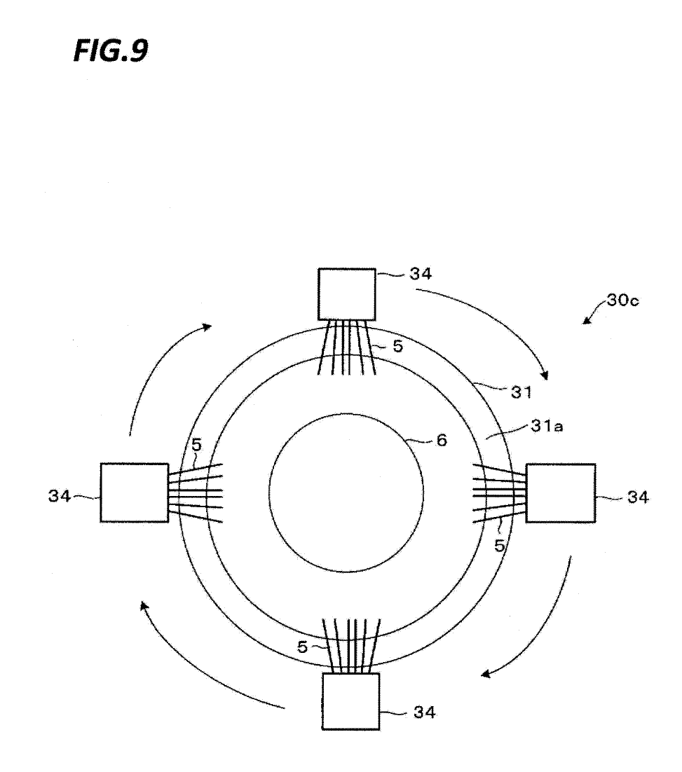

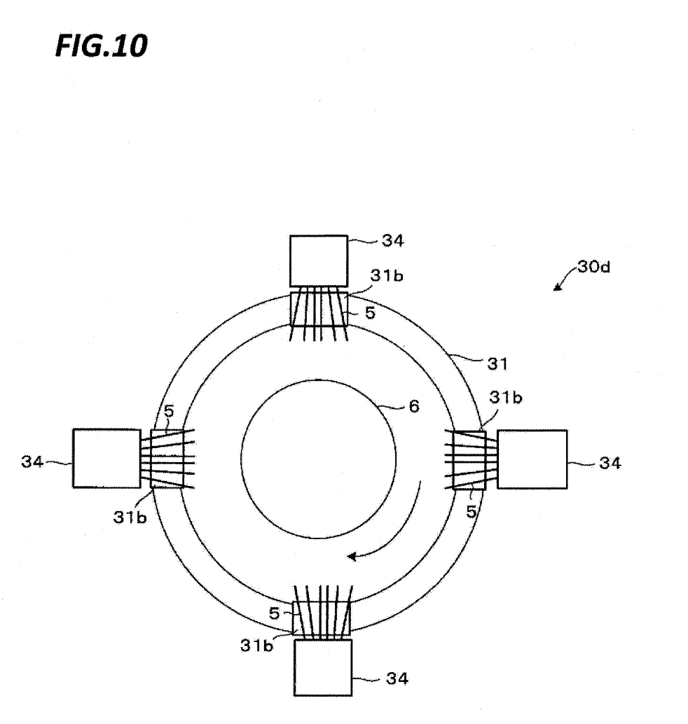

Further, in order to irradiate the ultraviolet rays 5 more uniformly to the whole resin layer 3 through the template 6, a plurality of (e.g., four in an example illustrated in FIGS. 9 and 10) UV light sources 34 may be used, for example, as illustrated in FIGS. 9 and 10. Further, the ultraviolet rays 5 may be irradiated from the whole circumference of the lateral surface of the template 6 by relatively rotating the template 6 and the UV light sources 34. Although only the template 6 is illustrated in FIGS. 9 and 10, the imprint modules 30c, 30d are also provided with the upper stage 32 and the lower stage 33, which are not illustrated, as in the imprint module 30 as illustrated in FIG. 3.

In the imprint module 30c illustrated in FIG. 9, an annular UV irradiation window 31a is formed in the processing chamber 31, and configured to irradiate the ultraviolet rays 5 from the whole circumference of the lateral surface of the template 6 by rotating the UV light sources 34 around the processing chamber 31 as indicated by arrows in the figure.

Meanwhile, in the imprint module 30d illustrated in FIG. 10, a UV irradiation window 31b is formed in each area of the processing chamber 31 where a UV light source 34 is provided. As indicated by arrows in the figure, the ultraviolet rays 5 are irradiated from the whole circumference of the lateral surface of the template 6 by rotating the template 6 (also the substrate 1, the upper stage 32, and the lower stage 33).

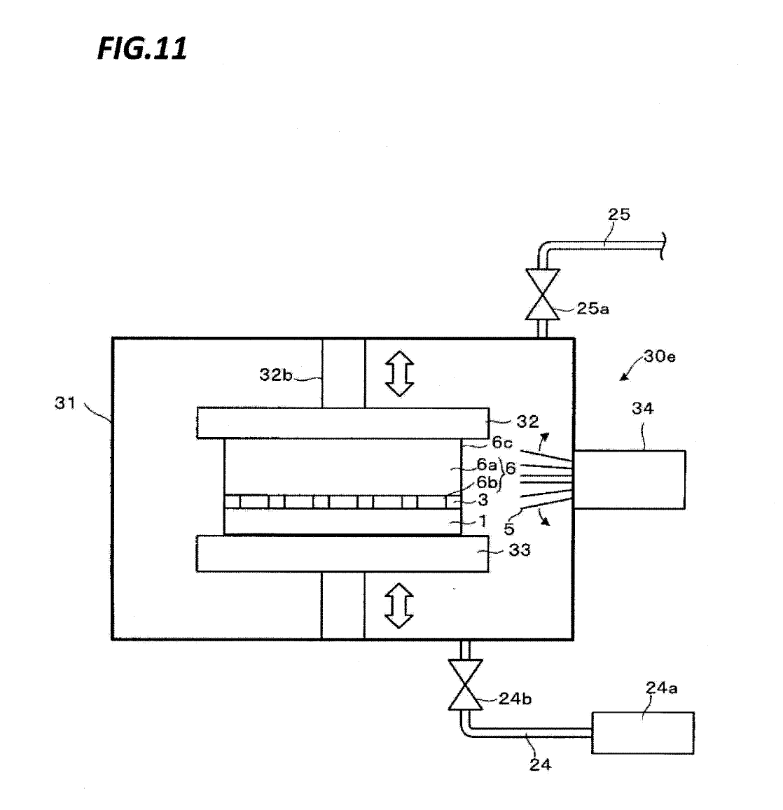

Further, for example, as in an imprint module 30e as illustrated in FIG. 11, the incidence angle of the ultraviolet rays 5 to the template 6 may be changed or allowed to fluctuate by vertically swinging the UV light source 34, which allows the ultraviolet rays 5 to be incident from the lateral surface of the template, as indicated by an arrow in the figure. When the ultraviolet rays 5 are incident from the lateral surface of the template 6, the ultraviolet rays 5 need to be incident to the template 6 at a proper angle in order to send the light path to a deeper portion in the template. The proper angle is varied depending on the size of the template 6, the shape of the pattern portion 6b, and the structure of the upper stage 32. Therefore, the incidence angle of the ultraviolet rays 5 to the template 6 may be set to be changeable. Further, since the ultraviolet rays 5 are able to be irradiated more uniformly to the resin layer 3 by allowing the incidence angle to fluctuate during the irradiation of the ultraviolet rays 5, more uniform curing may be performed. Further, in FIG. 11, the portions corresponding to the imprint module 30 as illustrated in FIG. 3 will be denoted by the same reference numerals, and the redundant descriptions thereof will be omitted.

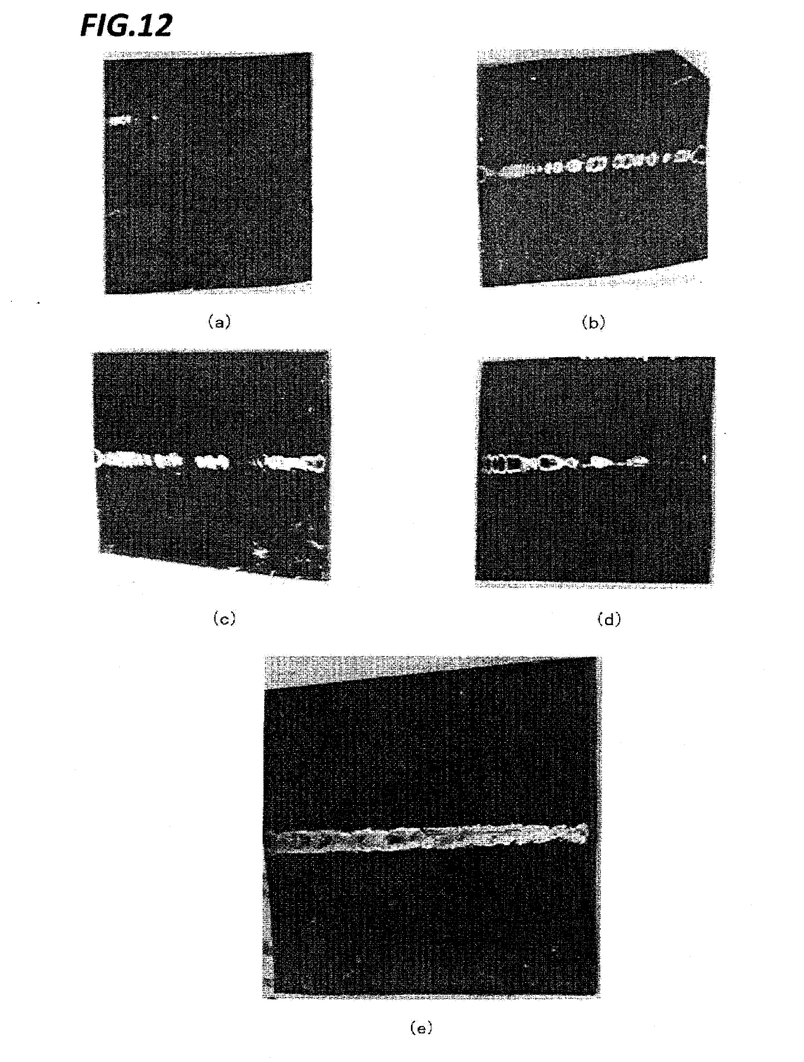

FIG. 12 illustrates micrographs representing results of using a laser beam as the ultraviolet rays 5 to examine the relationship between the incidence angle from the lateral surface of the template 6 and the solidification state of the resin. FIG. 12(a) illustrates a case where the incidence angle is 0°, that is, the laser beam is incident in parallel to the surface of the template 6, FIG. 12(b) illustrates a case where the incidence angle is 0.1°, FIG. 12(c) illustrates a case where the incidence angle is 0.2°, FIG. 12(d) illustrates a case where the incidence angle is 0.4°, and FIG. 12(e) illustrates a case where the incidence angle is allowed to fluctuate.

As illustrated in FIG. 12(a), in the case where the laser beam is incident in parallel to the surface of the template 6, the resin is hardly cured because the laser beam is hardly incident into the resin layer. Further, as illustrated in FIG. 12(b) to FIG. 12(d), when a certain incidence angle is set, the laser beam advances in the template 6 while being reflected, thereby being incident into the resin layer. Accordingly, cured portions of the resin (white portions in the photographs) appear intermittently and change the incidence angle. Thus, the light path of the laser beam is changed. Hence, the positions of the cured portions of the resin are changed. In addition, when the incidence angle is fluctuated as illustrated in FIG. 12(e), the overall curing proceeds. Therefore, particularly, in a case of using a laser beam, it is preferable to change the incident angle. In this case, the incidence angle of the laser beam preferably fluctuates within a range of, for example, ±0.5°.

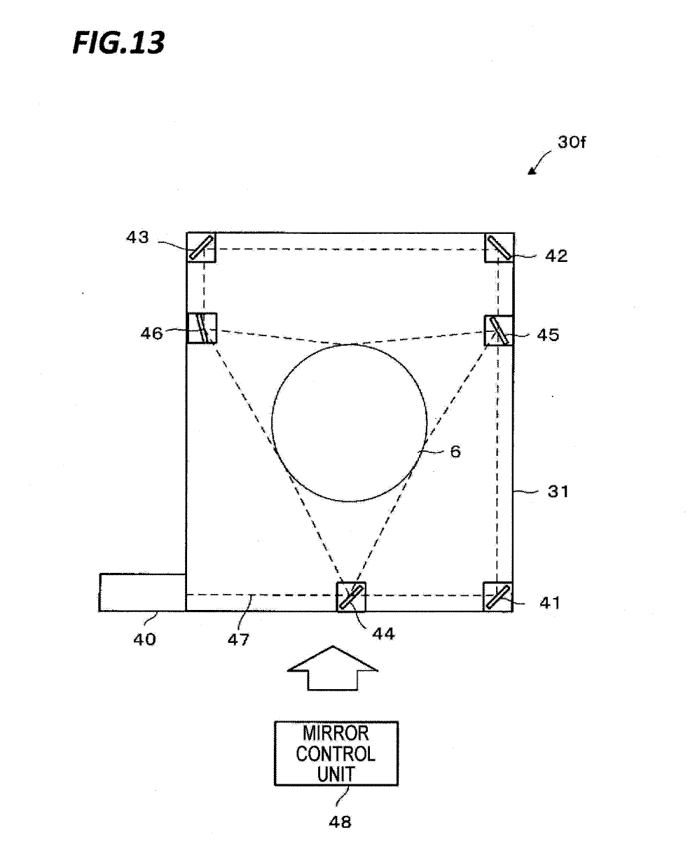

Further, as in an imprint module 30f as illustrated in FIG. 13, a laser beam 47 may be incident from the circumference of the template 6 using a laser beam source 40 and using fixed mirrors 41, 42, 43 and rotary mirrors 44, 45, 46. In this case, the laser beam 47 may be scanned to be incident to the template by pivoting the rotary mirrors 44, 45, 46 by control of the mirror control unit 48.

In the imprint module 30f illustrated in FIG. 13, the laser beam source 40 is provided at a corner of a rectangular processing chamber 31, and configured to irradiate the laser beam 47 along a sidewall of the processing chamber 31. And, the light path of the laser beam 47 is bent at a substantially right angle by the fixed mirrors 41, 42, 43 provided at the remaining three corners, respectively, and the laser beam 47 is reflected towards a direction of the template 6 by the rotary mirrors 44, 45, 46 provided on three sides of the processing chamber 31, respectively. In this case, each of the rotary mirrors 44, 45 is configured as a half mirror which reflects a part of the laser beam 47 and transmits the rest. Further, although FIG. 13 illustrates the template 6 only, the imprint module 30f is also provided with mechanisms such as the upper stage 32 and the lower stage 33, which are not illustrated, similarly to the imprint module 30 illustrated in FIG. 3.

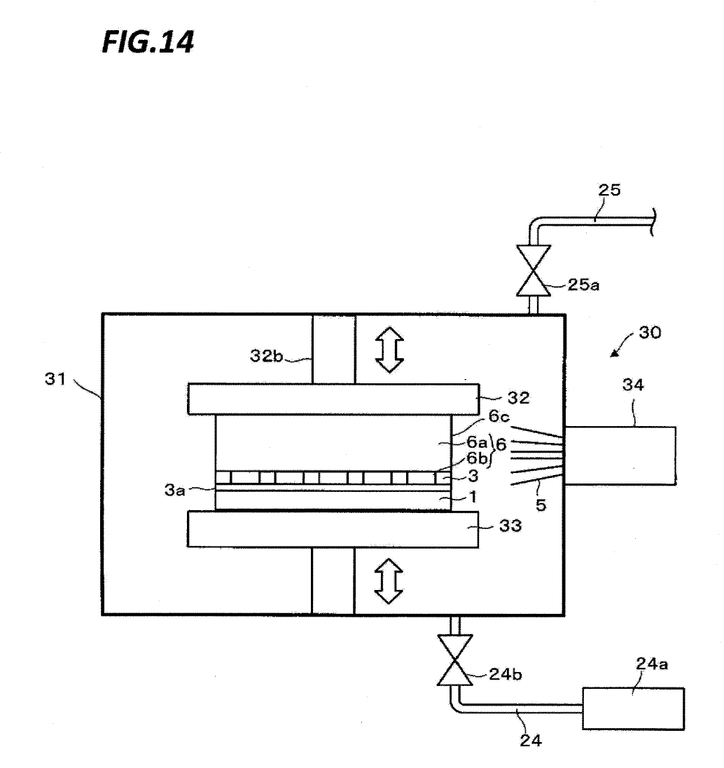

Further, as illustrated in FIG. 14, an undercoat layer 3a may be provided between the substrate 1 and the resin layer 3. When the refractive index of the undercoat layer 3a is set to be lower than the refractive index of the resin layer 3, the ultraviolet rays 5, which are introduced into the resin layer 3 to be incident from the resin layer 3 to the undercoat layer 3a, may be reflected on the boundary between the resin layer 3 and the undercoat layer 3a to be directed towards the inside of the resin layer 3. With such a configuration, the ultraviolet rays 5 introduced into the template 6 may be efficiently introduced into the resin layer 3 of the substrate 1. For example, when the refractive index of the substrate 1 and the refractive index of the resin layer 3 satisfies the following relationship:

Refractive index of Resin layer 3≦Refractive index of Substrate 1,

an undercoat layer 3a may be provided to satisfy the following relationship:

Refractive index of Undercoat layer 3a<Refractive index of Resin layer 3

Further, the undercoat layer 3a may be provided to enhance the adhesion between the substrate 1 and the resin layer 3. Also, in this case, in order that the ultraviolet rays 5, which are introduced into the resin layer 3 to be incident from the resin layer 3 to the undercoat layer 3a, are reflected on the boundary between the resin layer 3 and the undercoat layer 3a to be directed towards the inside of the resin layer 3, the undercoat layer 3a may be provided to satisfy the following relationship:

Refractive index of Undercoat layer 3a<Refractive index of Resin layer 3

In this case, the relationship may further satisfy:

Refractive index of Substrate 1<Refractive index of Resin layer 3

or

Refractive index of Resin layer 3<Refractive index of Substrate 1

From the foregoing, preferred embodiments of the present disclosure were described with reference to the accompanying drawings, but the present disclosure is not limited thereto. It will be appreciated by those skilled in the art that various modifications may be made within the scope of the spirit described in the following claims of the present disclosure. Accordingly, it is understood that their equivalents belong to the technical scope of the present disclosure.

### INDUSTRIAL APPLICABILITY

The present disclosure is available in the manufacture of semiconductor devices and the manufacture of liquid crystal devices. Accordingly, the present disclosure has an industrial applicability.

### DESCRIPTION OF SYMBOL

1: substrate
2: photo-curable resin
3: resin layer
4: resin pattern
5: ultraviolet rays
6: template

1. An imprint device comprising:
a template provided with a plate-shaped template body and a pattern portion having a predetermined shape formed on a surface of the template body;
a template holding mechanism configured to hold the template;
a substrate holding mechanism configured to hold a substrate formed with a resin layer made of a photo-curable resin in a state where the pattern portion of the template and the resin layer are in contact with each other; and
a light irradiating mechanism configured to irradiate a light in a wavelength range for curing the photo-curable resin,
wherein the template is configured to allow the light to be incident from a lateral surface of the template body, and
the light irradiating mechanism is configured to irradiate the light to the resin layer by allowing the light to be incident from the lateral surface of the template body and transmitted through the template body.

2. The imprint device of claim 1, wherein the light irradiating mechanism is configured to be able to change an incidence angle of the light to the template body.

3. The imprint device of claim 1, wherein the light irradiating mechanism is provided with a light source disposed at the side of the template body.

4. The imprint device of claim 1, wherein a reflecting unit is provided at a rear surface side of the template body to reflect the light incident from the light irradiating mechanism into the template body.

5. The imprint device of claim 1, wherein a reflecting unit is provided in the template holding mechanism to reflect the light incident from the light irradiating mechanism into the template body.

6. The imprint device of claim 4, wherein the reflecting unit has a refractive index lower than that of a portion that transmits the light incident from the light irradiating mechanism of the template body.

7. The imprint device of claim 4, wherein the reflecting unit is formed with unevenness on its surface.

8. The imprint device of claim 1, further comprising:
a rotating mechanism configured to rotate the template holding mechanism, the template and the substrate holding mechanism when the light is irradiated from the light irradiating mechanism.

9. The imprint device of claim 1, wherein the light irradiating mechanism is provided with a driving mechanism configured to change an incidence position of the light on the template.

10. The imprint device of claim 1, wherein the light irradiating mechanism is provided with a plurality of reflecting mechanisms configured to reflect the light irradiated from the light source and allow the light to be incident from the lateral surface of the template body.

11. The imprint device of claim 10, wherein the reflecting mechanism is provided with a reflecting mechanism control unit configured to drive the reflecting mechanism to change a light path of the light.

12. The imprint device of claim 1, wherein the template body has a refractive index lower than that of the resin layer.

13. The imprint device of claim 1, wherein the resin has a refractive index higher than that of the substrate.

14. The imprint device of claim 1, wherein an undercoat layer is formed between the resin layer and the substrate, and the undercoat layer has a refractive index lower than that of the resin layer.

15. A template comprising:
a plate-shaped template body; and
a pattern portion having a predetermined shape formed on a surface of the template body,
wherein the template is configured to transfer the shape in the pattern portion to a resin layer made of a photo-curable resin by holding a substrate formed with the resin layer in a state where the pattern portion and the resin layer are in contact with each other, and curing the resin layer by irradiation of a light, and
the template is configured such that the light is incident from a lateral surface of the template body, and the resin layer is irradiated with the light by allowing the light to be incident from the lateral surface of the template body and transmitted through the template body.

16. The template of claim 15, wherein a reflecting unit is provided at a rear surface side of the template body in order to reflect the light incident from the light irradiating mechanism into the template body.

17. The imprint device of claim 5, wherein the reflecting unit has a refractive index lower than that of a portion that transmits the light incident from the light irradiating mechanism of the template body.

18. The imprint device of claim 5, wherein the reflecting unit is formed with unevenness on its surface.
